(19) United States
(12) Patent Application Publication
(10) Pub. No.: US 2011/0078890 A1
(43) Pub. Date: Apr. 7, 2011

(54) METHOD FOR ALIGNING AN ELONGATED COMPONENT

(75) Inventors: Axel Bormann, Bamberg (DE); Johann Bayer, Strullendorf (DE)

(73) Assignee: ROBERT BOSCH GMBH, Stuttgart (DE)

(21) Appl. No.: 12/735,532

(22) PCT Filed: Feb. 23, 2009
(86) PCT No.: PCT/EP2009/052117

§ 371 Date: Oct. 18, 2010

(30) Foreign Application Priority Data
Feb. 25, 2008 (DE) 102008010976.2

(51) Int. Cl. B23Q 3/00

(52) U.S. Cl. 29/464

(57) ABSTRACT

A method for aligning an elongated component that is to be fitted, with at least two component segments, into two coaxial installation points (A/B; C) spaced apart from one another. In this context, the coaxiality of the component segments is checked and any existing deviation from coaxiality is measured. At least one material fusion area, limited radially and in a circumferential direction, is generated in a surface region of the component located between the component segments, at a magnitude such that as a result of the axial shrinkage ensuing upon cooling of the material fusion area, coaxiality of the component segments is produced at least within tolerable limits.

### BACKGROUND OF THE INVENTION

1. Field of the Invention

The present invention relates to a method for aligning an elongated component that is to be fitted, with at least two component segments, into two coaxial installation points spaced apart from one another.

2. Description of Related Art

Fuel injection systems for multi-cylinder internal combustion engines have fuel injection valves, one of which is allocated to each combustion cylinder of the internal combustion engine, and a fuel distributor connected to the fuel injection valves, through which fuel is delivered at high pressure to the fuel injection valves. The fuel injection valves are usually fitted into bores in the cylinder head and protrude, with a valve neck formed by the valve seat carrier, into a combustion chamber of a combustion cylinder of the internal combustion engine. Oppositely therefrom, elongated tubular fuel connector fittings of the fuel injection valves project out of the cylinder head bores and are fitted into tubular fittings of the fuel distributor. The axes of the tubular fittings are aligned coaxially with the axes of the cylinder head bores. It is therefore absolutely necessary, for installation of the fuel injection valves, that the segment of the fuel injection valve received in the cylinder head bore, and the segment of the fuel injection valve to be inserted into the tubular fitting, be aligned exactly coaxially, so that upon automated assembly, the fuel distributor can be placed with its tubular fitting onto the connector fittings of the fuel injection valves secured in the cylinder head bores.

Because of the extreme length-to-diameter ratio of the fuel injection valves, the tubular valve seat carrier and the tubular connector fitting are usually fabricated from two separate sleeves that are intermaterially connected to one another. The intermaterial connection is preferably achieved by welding, by producing a circumferential weld seam at the abutting point of the two sleeves. The two sleeves become distorted in the context of welding, however, so that coaxiality between the two valve segments, retained on the one hand in the cylinder head bore and on the other hand in the tubular fitting of the fuel distributor (so-called “concentricity”), no longer exists with the required accuracy.

In the context of a known method for welding together two cylindrical elements, for example a valve element and a magnet armature of a fuel injection valve (published German patent application DE 102 07 146 A1), in order to avoid deformation of the cylindrical elements as a result of welding, the two hollow cylindrical elements that are inserted in positively fitting fashion into one another are rotated about their center axis during welding, and welding is performed using two energy sources offset 90° from one another on the circumference. The cylindrical elements are thereby, in segments, melted and welded a first time by the first energy source, and melted and welded a second time by the second energy source.

### SUMMARY OF THE INVENTION

The method according to the present invention for aligning an elongated component has the advantage that a non-coaxiality present in the component between the installation regions on the component that are provided for installation, which non-coaxiality occurs e.g. in the context of joining two component parts and welding them together, can be eliminated in a manner that is simple in terms of production engineering. In this context, a concentricity accuracy, i.e. coaxiality, that is referred to the length of the component is achieved between the axes of the two installation regions of the component. In fuel injection valves, for example, in which the tubular component assembled from a valve seat carrier and connector fitting has at least one installation segment provided on the valve seat carrier and one close to the free end of the connector fitting, a concentricity accuracy from 50 to 150 μm, for a spacing of approx. 100 mm between the installation segments on the component, is achievable with the method according to the present invention.

### BRIEF DESCRIPTION OF THE SEVERAL VIEWS OF THE DRAWINGS

The invention is explained further in the description below with reference to exemplifying embodiments depicted in the drawings, in which:

FIG. 1 is a longitudinal section through a fuel injection valve for internal combustion engines, having an elongated component assembled from a hollow-cylindrical connector fitting and a hollow-cylindrical valve seat carrier.

FIG. 2 is a longitudinal section through the component in FIG. 1, with the connector fitting and valve seat carrier in the joined position.

FIG. 3 is the same depiction as in FIG. 2, after intermaterial connection of the connector fitting and valve seat carrier.

FIG. 4 is the same depiction as in FIG. 3, after alignment of the component.

FIG. 5 is the same depiction as in FIG. 2, with modified joining of the connector fitting and valve seat carrier.

FIG. 6 is a side view of a component assembled from a connector fitting and valve seat carrier and having an electromagnet, locally surrounding the valve seat carrier, of a fuel injection valve, according to a further exemplifying embodiment.

### DETAILED DESCRIPTION OF THE INVENTION

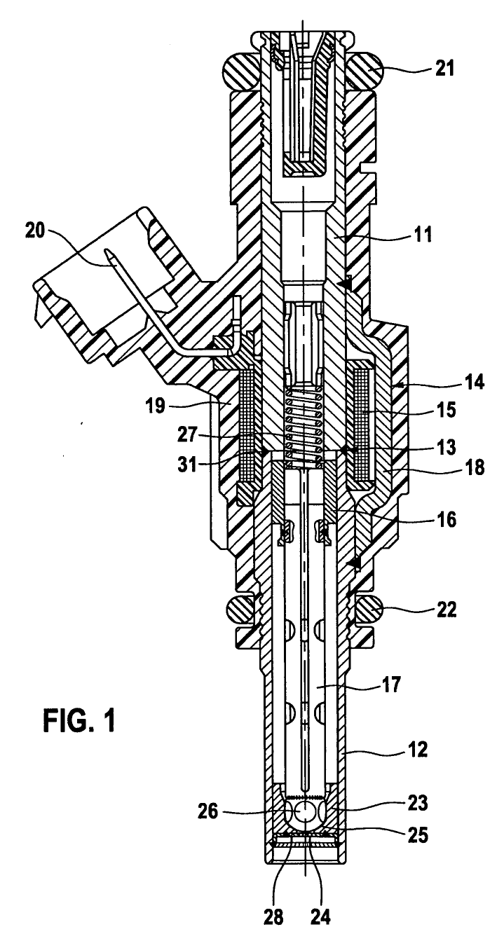

The electromagnetically actuated fuel injection valve depicted in longitudinal section in FIG. 1 has a hollow-cylindrical connector fitting 11 and, placed against the end face thereof, a hollow-cylindrical valve seat carrier 12, which are assembled in intermaterially connected fashion to yield an elongated tubular component 13. In the exemplifying embodiment described, the intermaterial connection is created by a circumferential weld seam 31 at the abutting point of connector fitting 11 and valve seat carrier 12. Tubular component 13 is surrounded, in the region of the abutting point, by an electromagnet 14 that has a solenoid 15, an armature 16, and a magnet cup 18. Armature 16 is guided axially displaceably in valve seat carrier 12, and is fixedly connected to a valve needle 17. A working air gap of electromagnet 14 is present between armature 16 and the end of connector fitting 11 disposed axially opposite it. Magnet cup 18, which closes the electromagnetic circuit through armature 16, is fastened externally on the connector fitting and on valve seat carrier 12. Connector fitting 11, electromagnet 14, and (in part) valve seat carrier 12 are encapsulated by a plastic housing 10 into which an electrical plug connector 20 for solenoid 15 is integrated. The fuel injection valve is inserted into a cylinder head bore of an internal combustion engine which is embodied as a stepped bore; plastic housing 10 rests against the bore wall of the larger-diameter bore segment in the region of electromagnet 14, and a sealing ring 22, disposed in the region of valve seat carrier 12 on plastic housing 10, seals the fuel injection valve with respect to the bore wall of the smaller-diameter bore segment. Valve seat carrier 12, projecting partly into the combustion chamber of a combustion cylinder of the internal combustion engine, carries in its free end a valve body 23 into which are recessed a valve opening 24 and a valve seat 25 surrounding valve opening 24. Valve body 23 is welded together with a perforated spray disk 28 on valve seat carrier 12. Welded to the end of valve needle 17 facing away from armature 16 is a spherical closure element 26, coacting with valve seat 25, that is pressed via valve needle 17 onto valve seat 25 by a valve closure spring 27 that is braced in connector fitting 11. The fuel volume sprayed out of valve opening 24 as closure element 26 lifts off from valve seat 25 is widened by perforated spray disk 28 into a fan-like stream of fuel.

The fuel injection valve is inserted, with its free end toward the connector fitting, into a tubular fitting of a fuel distributor (not depicted here) and is sealed against the tubular wall of the tubular fitting by way of a sealing ring 21 that braces against the end face of plastic housing 19. For proper fitting of the injection valve into the cylinder head bore on the one hand and into the tubular fitting of the fuel distributor on the other, it is necessary that the retaining regions of the fuel injection valve in the cylinder head bore and in the tubular fitting be oriented coaxially. In order to ensure this coaxiality, axes 111, 121 of connector fitting 11 and of valve seat carrier 12 must be in line with one another, but at least those regions of component 13 assembled from connector fitting 11 and valve seat carrier 12 that are fastened in the tubular fitting and cylinder head bore must be lined up coaxially. Because a distortion usually occurs when connector fitting 11 and valve seat carrier 12 are welded together to form component 13, this coaxiality (called “concentricity”) is not guaranteed, and is produced by alignment of the component subsequent to welding. The procedure for this is as follows:

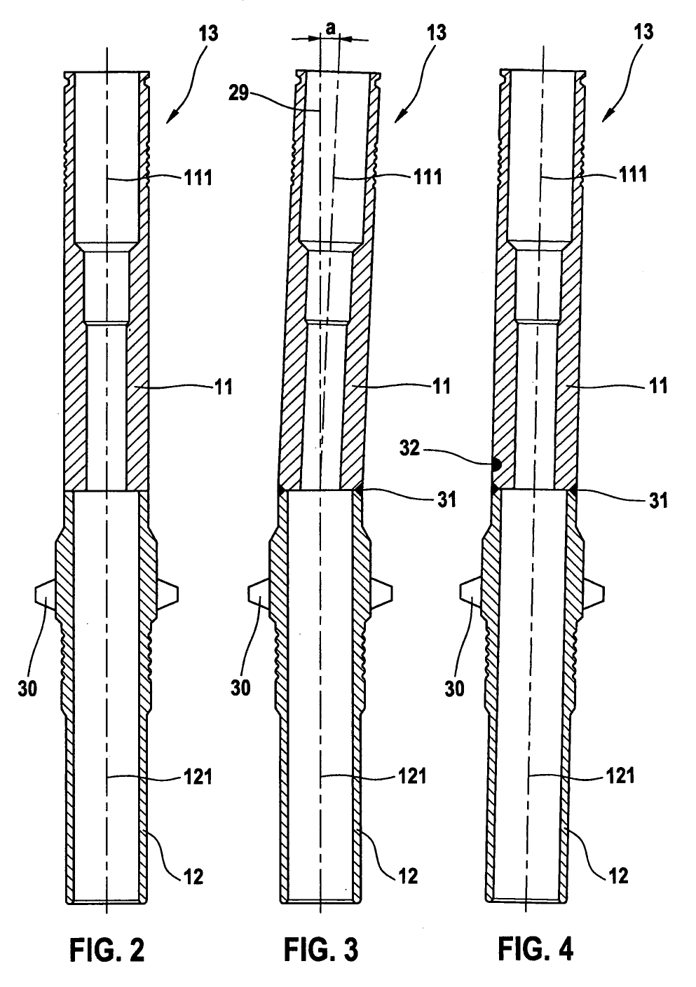

Valve seat carrier 12 is retained in clamping jaws 30 of a holding apparatus (FIG. 2). Connector fitting 11 and valve seat carrier 12 are then joined, by abutting the end of connector fitting 11 onto the retained valve seat carrier 12. Connector fitting 11 and valve seat carrier 12 are welded to one another at their interface along the circumference, using a welding apparatus, e.g. a welding laser. The circumferential weld seam resulting in that context is labeled 31 in FIGS. 3 and 4. Connector fitting 11 usually becomes distorted upon welding, and an offset or deflection a of axis 111 of connector fitting 11 is produced with respect to alignment line 23 coaxial with axis 121 of valve seat carrier 12 (FIG. 3). Once the welding point has cooled, the magnitude and direction of deflection a are measured. In a surface region, diametrical with respect to the direction of deflection a, of component 13 made up of connector fitting 11 and valve seat carrier 12, between the component segments that serve for fastening in the tubular fitting of the fuel distributor and in the cylinder head bore, a material fusion area 32, limited radially and in the circumferential direction, is generated at a magnitude such that the axial shrinkage occurring upon cooling of material fusion area 32 annuls the measured deflection a, so that the component segments serving for fitting into the tubular fitting of the fuel distributor and the cylinder head bore are once again mutually coaxial within tolerable limits. In the exemplifying embodiment shown in FIGS. 3 and 4, material fusion area 32 is generated in the surface region of connector fitting 11 close to weld seam 31, so that once the material fusion area has cooled, axes 111 and 121 of connector fitting 11 and of valve seat carrier 12 once again line up with one another, as depicted in FIG. 4. The partial material fusion area 32 is preferably generated using a laser. The location of the material fusion area, the melting depth, and the length (viewed in a circumferential direction) of material fusion area 32 are taken from a characteristics diagram in which these values are stored in correlation with the direction and magnitude of deflection a. The characteristics diagram has been ascertained empirically. If a first material fusion area 32, implemented as described, does not yet yield the desired result, then at least one further material fusion area is carried out at a short distance (viewed in a circumferential direction) from the first material fusion area 32.

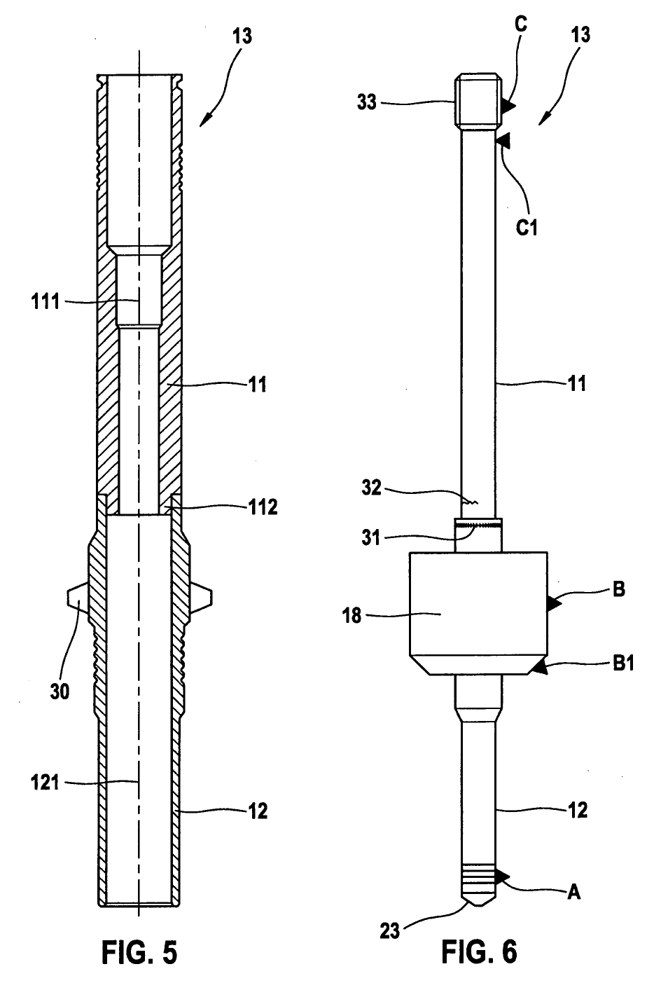

In the case of the exemplifying embodiment of component 13, depicted in longitudinal section in FIG. 5, that once again is assembled from connector fitting 11 and valve seat carrier 12, the manner in which they are joined prior to intermaterial connection is modified. Connector fitting 11 and valve seat carrier 12 no longer rest in abutment against one another; instead, connector fitting 11 penetrates, with a reduced-diameter end segment 112, in positively engaged fashion into valve seat carrier 12. Intermaterial connection (once again welding in this case) is accomplished in the overlap region between connector fitting 11 and valve seat carrier 12. A distortion of component 13 occurring after welding is compensated for in the manner described above.

FIG. 6 is a side view depicting a further exemplifying embodiment of an oriented, elongated component 13. The component is once again assembled from a tubular connector fitting 11 and a tubular valve seat carrier 12, which are intermaterially connected to one another in the region of weld seam 31. Valve seat carrier 12 is enclosed locally by electromagnet 14, whose magnet housing 18 is welded onto valve seat carrier 12. When it is later used as a fuel injection valve, component 13 is fastened in the cylinder head bore at the points identified in FIG. 6 as A and B, or A and B1, with the result that axis 121 of valve seat carrier 12 is aligned coaxially with the bore axis. Component 13 is furthermore fastened in the tubular fitting of the fuel distributor in the component segment labeled C, and has for that purpose an external thread segment 33, embodied at the end of connector fitting 11, for threading into the tubular fitting (equipped with an internal thread) of the fuel distributor. An example of such a fuel distributor is found in EP 1 359 317 A1. Because the component distorts when connector fitting 11 is welded onto valve seat carrier 12, it is necessary to align component 13 so that component segment C is aligned coaxially with the component segment between retention points A and B or A and B1, i.e. substantially coaxially with axis 121 of valve seat carrier 12. This is achieved once again with material fusion area 32 generated with a laser in the surface region of component 13, which area has been introduced in the region between component segment C and component segment B/A or B1/A. The concentricity of component 13 is measured at point C1 in FIG. 6.

The alignment method described above is not limited to the welding together of a connector fitting and a valve seat carrier for a fuel injection valve. Instead, any tubes or sleeve or other elongated elements can be intermaterially connected to one another and then aligned in the manner described. In the same fashion, one-piece elongated components that exhibit a distortion over their length can also be aligned in the manner described.

1-10. (canceled)

11. A method for aligning an elongated component that is to be fitted, with at least two component segments, into two coaxial installation points spaced apart from one another, comprising: checking coaxiality of the component segments and measuring any existing deviation from coaxiality; and generating at least one material fusion area, limited radially and in a circumferential direction, in a surface region of the component located between the component segments, at a magnitude such that as a result of axial shrinkage ensuing upon cooling of the material fusion area, coaxiality of the component segments is produced at least within tolerable limits.

12. The method as recited in claim 11, wherein the deviation from coaxiality is measured in terms of magnitude and radial direction, and generation of the at least one material fusion area is carried out in the surface region of the component diametrical with respect to the measured direction of the deviation.

13. The method as recited in claim 11, wherein multiple material fusion areas are generated, spaced apart from one another in a circumferential direction next to one another.

14. The method as recited in claim 12, wherein multiple material fusion areas are generated, spaced apart from one another in a circumferential direction next to one another.

15. The method as recited in claim 11, wherein generation of the at least one material fusion area is carried out with a laser.

16. The method as recited in claim 12, wherein generation of the at least one material fusion area is carried out with a laser.

17. The method as recited in claim 13, wherein generation of the material fusion areas is carried out with a laser.

18. The method as recited in claim 11, wherein the elongated component is made up of at least two pieces, joined to one another, that are intermaterially connected to one another; and the at least one material fusion area is generated close to the connecting point of the two component pieces.

19. The method as recited in claim 12, wherein the elongated component is made up of at least two pieces, joined to one another, that are intermaterially connected to one another; and the at least one material fusion area is generated close to the connecting point of the two component pieces.

20. The method as recited in claim 13, wherein the elongated component is made up of at least two pieces, joined to one another, that are intermaterially connected to one another; and the material fusion areas are generated close to the connecting point of the two component pieces.

21. The method as recited in claim 15, wherein the elongated component is made up of at least two pieces, joined to one another, that are intermaterially connected to one another; and the at least one material fusion area is generated close to the connecting point of the two component pieces.

22. The method as recited in claim 18, wherein joining of the component pieces is performed by butting together the mutually facing end surfaces of the component pieces.

23. The method as recited in claim 19, wherein joining of the component pieces is performed by butting together the mutually facing end surfaces of the component pieces.

24. The method as recited in claim 18, wherein joining of the component pieces is performed by placing the one component piece onto or into the other component piece in positively engaged fashion.

25. The method as recited in claim 19, wherein joining of the component pieces is performed by placing the one component piece onto or into the other component piece in positively engaged fashion.

26. The method as recited in claim 18, wherein the component pieces are hollow cylinders.

27. The method as recited in claim 26, wherein the component pieces are tubes or sleeves.

28. The method as recited in claim 18, wherein the intermaterial connection between the component pieces is created by welding.

29. The method as recited in claim 18, wherein a hollow-cylindrical connector fitting, and a hollow-cylindrical valve seat carrier that is locally surrounded by an electromagnet having a magnet housing, of a fuel injection valve are used as component pieces to be joined to one another and intermaterially connected; and the component segments to be fitted are associated on the one hand with a free end of the connector fitting, and on the other hand with the magnet housing and with an end of the valve seat carrier facing away from the magnet housing.

30. The method as recited in claim 19, wherein a hollow-cylindrical connector fitting, and a hollow-cylindrical valve seat carrier that is locally surrounded by an electromagnet having a magnet housing, of a fuel injection valve are used as component pieces to be joined to one another and intermaterially connected; and the component segments to be fitted are associated on the one hand with a free end of the connector fitting, and on the other hand with the magnet housing and with an end of the valve seat carrier facing away from the magnet housing.
